(19) United States
(12) Patent Application Publication
(10) Pub. No.: US 2014/0139632 A1
(43) Pub. Date: May 22, 2014

(54) DEPTH IMAGING METHOD AND APPARATUS WITH ADAPTIVE ILLUMINATION OF AN OBJECT OF INTEREST

(71) Applicant: LSI CORPORATION, Milpitas, CA (US)

(72) Inventor: Boris Livshitz, Mendota Heights, MN (US)

(73) Assignee: LSI Corporation, Milpitas, CA (US)

(21) Appl. No.: 13/683,042

(22) Filed: Nov. 21, 2012

(51) Int. Cl. H04N 13/02

(52) U.S. Cl. CPC H04N 13/0203
USPC 348/46

(57) ABSTRACT

A depth imager such as a time of flight camera or a structured light camera is configured to capture a first frame of a scene using illumination of a first type, to define a first area associated with an object of interest in the first frame, to identify a second area to be adaptively illuminated based on expected movement of the object of interest, to capture a second frame of the scene with adaptive illumination of the second area using illumination of a second type different than the first type, possibly with variation in at least one of output light amplitude and frequency, and to attempt to detect the object of interest in the second frame. The illumination of the first type may comprise substantially uniform illumination over a designated field of view, and the illumination of the second type may comprise illumination of substantially only the second area.

### BACKGROUND

A number of different techniques are known for generating three-dimensional (3D) images of a spatial scene in real time. For example, 3D images of a spatial scene may be generated using triangulation based on multiple two-dimensional (2D) images captured by multiple cameras at different locations. However, a significant drawback of such a technique is that it generally requires very intensive computations, and can therefore consume an excessive amount of the available computational resources of a computer or other processing device. Also, it can be difficult to generate an accurate 3D image under conditions involving insufficient ambient lighting when using such a technique.

Other known techniques include directly generating a 3D image using a depth imager such as a time of flight (ToF) camera or a structured light (SL) camera. Cameras of this type are usually compact, provide rapid image generation, and operate in the near-infrared part of the electromagnetic spectrum. As a result, ToF and SL cameras are commonly used in machine vision applications such as gesture recognition in video gaming systems or other types of image processing systems implementing gesture-based human-machine interfaces. ToF and SL cameras are also utilized in a wide variety of other machine vision applications, including, for example, face detection and singular or multiple person tracking.

A typical conventional ToF camera includes an optical source comprising, for example, one or more light-emitting diodes (LEDs) or laser diodes. Each such LED or laser diode is controlled to produce continuous wave (CW) output light having substantially constant amplitude and frequency. The output light illuminates a scene to be imaged and is scattered or reflected by objects in the scene. The resulting return light is detected and utilized to create a depth map or other type of 3D image. This more particularly involves, for example, utilizing phase differences between the output light and the return light to determine distances to the objects in the scene. Also, the amplitude of the return light is used to determine intensity levels for the image.

A typical conventional SL camera includes an optical source comprising, for example, a laser and an associated mechanical laser scanning system. Although the laser is mechanically scanned in the SL camera, it nonetheless produces output light having substantially constant amplitude. However, the output light from the SL camera is not modulated at any particular frequency as is the CW output light from a ToF camera. The laser and mechanical laser scanning system are part of a stripe projector of the SL camera that is configured to project narrow stripes of light onto the surface of objects in a scene. This produces lines of illumination that appear distorted at a detector array of the SL camera because the projector and the detector array have different perspectives of the objects. A triangulation approach is used to determine an exact geometric reconstruction of object surface shape.

Both ToF and SL cameras generally operate with uniform illumination of a rectangular field of view (FoV). Moreover, as indicated above, the output light produced by a ToF camera has substantially constant amplitude and frequency, and the output light produced by an SL camera has substantially constant amplitude.

### SUMMARY

In one embodiment, a depth imager is configured to capture a first frame of a scene using illumination of a first type, to define a first area associated with an object of interest in the first frame, to identify a second area to be adaptively illuminated based on expected movement of the object of interest, to capture a second frame of the scene with adaptive illumination of the second area using illumination of a second type different than the first type, and to attempt to detect the object of interest in the second frame.

The illumination of the first type may comprise, for example, substantially uniform illumination over a designated field of view, and the illumination of the second type may comprise illumination of substantially only the second area. Numerous other illumination types may be used.

Other embodiments of the invention include but are not limited to methods, systems, integrated circuits, and computer-readable media storing program code which when executed causes a processing device to perform a method.

### BRIEF DESCRIPTION OF THE DRAWINGS

FIG. 1 is a block diagram of an image processing system comprising a depth imager configured with functionality for adaptive illumination of an object of interest in one embodiment.

FIG. 2 illustrates one type of movement of an object of interest in multiple frames.

FIG. 3 is a flow diagram of a first embodiment of a process for adaptive illumination of an object of interest in the FIG. 1 system.

FIG. 4 illustrates another type of movement of an object of interest in multiple frames.

FIG. 5 is a flow diagram of a second embodiment of a process for adaptive illumination of an object of interest in the FIG. 1 system.

### DETAILED DESCRIPTION

Embodiments of the invention will be illustrated herein in conjunction with exemplary image processing systems that include depth imagers having functionality for adaptive illumination of an object of interest. By way of example, certain embodiments comprise depth imagers such as ToF cameras and SL cameras that are configured to provide adaptive illumination of an object of interest. Such adaptive illumination may include, again by way of example, variations in both output light amplitude and frequency for a ToF camera, or variations in output light amplitude for an SL camera. It should be understood, however, that embodiments of the invention are more generally applicable to any image processing system or associated depth imager in which it is desirable to provide improved detection of objects in depth maps or other types of 3D images.

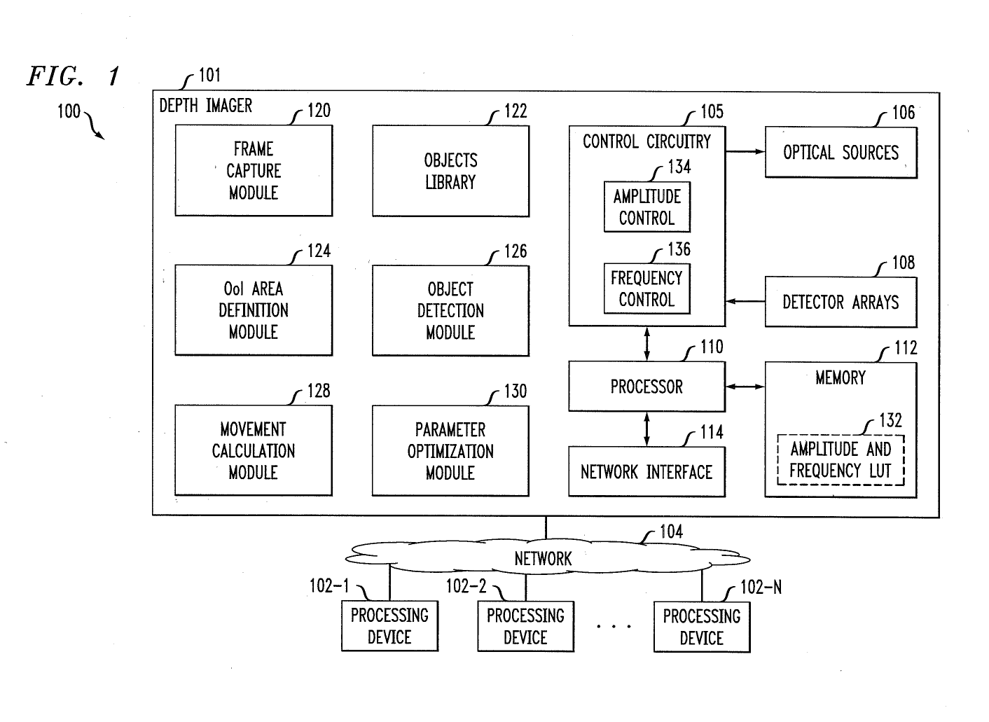

FIG. 1 shows an image processing system 100 in an embodiment of the invention. The image processing system 100 comprises a depth imager 101 that communicates with a plurality of processing devices 102-1, 102-2, . . . 102-N, over a network 104. The depth imager 101 in the present embodiment is assumed to comprise a 3D imager such as a ToF camera, although other types of depth imagers may be used in other embodiments, including SL cameras. The depth imager 101 generates depth maps or other depth images of a scene and communicates those images over network 104 to one or more of the processing devices 102. Thus, the processing devices 102 may comprise computers, servers or storage devices, in any combination. One or more such devices also may include, for example, display screens or other user interfaces that are utilized to present images generated by the depth imager 101.

Although shown as being separate from the processing devices 102 in the present embodiment, the depth imager 101 may be at least partially combined with one or more of the processing devices. Thus, for example, the depth imager 101 may be implemented at least in part using a given one of the processing devices 102. By way of example, a computer may be configured to incorporate depth imager 101.

In a given embodiment, the image processing system 100 is implemented as a video gaming system or other type of gesture-based system that generates images in order to recognize user gestures. The disclosed imaging techniques can be similarly adapted for use in a wide variety of other systems requiring a gesture-based human-machine interface, and can also be applied to numerous applications other than gesture recognition, such as machine vision systems involving face detection, person tracking or other techniques that process depth images from a depth imager.

The depth imager 101 as shown in FIG. 1 comprises control circuitry 105 coupled to optical sources 106 and detector arrays 108. The optical sources 106 may comprise, for example, respective LEDs, which may be arranged in an LED array. Although multiple optical sources are used in this embodiment, other embodiments may include only a single optical source. It is to be appreciated that optical sources other than LEDs may be used. For example, at least a portion of the LEDs may be replaced with laser diodes or other optical sources in other embodiments.

The control circuitry 105 comprises driver circuits for the optical sources 106. Each of the optical sources may have an associated driver circuit, or multiple optical sources may share a common driver circuit. Examples of driver circuits suitable for use in embodiments of the present invention are disclosed in U.S. patent application Ser. No. 13/658,153, filed Oct. 23, 2012 and entitled “Optical Source Driver Circuit for Depth Imager,” which is commonly assigned herewith and incorporated by reference herein.

The control circuitry 105 controls the optical sources 106 so as to generate output light having particular characteristics. Ramped and stepped examples of output light amplitude and frequency variations that may be provided utilizing a given driver circuit of the control circuitry 105 in a depth imager comprising a ToF camera can be found in the above-cited U.S. patent application Ser. No. 13/658,153. The output light illuminates a scene to be imaged and the resulting return light is detected using detector arrays 108 and then further processed in control circuitry 105 and other components of depth imager 101 in order to create a depth map or other type of 3D image.

The driver circuits of control circuitry 105 can therefore be configured to generate driver signals having designated types of amplitude and frequency variations, in a manner that provides significantly improved performance in depth imager 101 relative to conventional depth imagers. For example, such an arrangement may be configured to allow particularly efficient optimization of not only driver signal amplitude and frequency, but also other parameters such as an integration time window.

The depth imager 101 in the present embodiment is assumed to be implemented using at least one processing device and comprises a processor 110 coupled to a memory 112. The processor 110 executes software code stored in the memory 112 in order to direct at least a portion of the operation of the optical sources 106 and the detector arrays 108 via the control circuitry 105. The depth imager 101 also comprises a network interface 114 that supports communication over network 104.

The processor 110 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 112 stores software code for execution by the processor 110 in implementing portions of the functionality of depth imager 101, such as portions of modules 120, 122, 124, 126, 128 and 130 to be described below. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should therefore be appreciated that embodiments of the invention may be implemented in the form of integrated circuits. In a given such integrated circuit implementation, identical die are typically formed in a repeated pattern on a surface of a semiconductor wafer. Each die includes, for example, at least a portion of control circuitry 105 and possibly other image processing circuitry of depth imager 101 as described herein, and may further include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The network 104 may comprise a wide area network (WAN) such as the Internet, a local area network (LAN), a cellular network, or any other type of network, as well as combinations of multiple networks. The network interface 114 of the depth imager 101 may comprise one or more conventional transceivers or other network interface circuitry configured to allow the depth imager 101 to communicate over network 104 with similar network interfaces in each of the processing devices 102.

The depth imager 101 in the present embodiment is generally configured to capture a first frame of a scene using illumination of a first type, to define a first area associated with an object of interest in the first frame, to identify a second area to be adaptively illuminated based on expected movement of the object of interest, to capture a second frame of the scene with adaptive illumination of the second area using illumination of a second type different than the first type, and to attempt to detect the object of interest in the second frame.

A given such process may be repeated for one or more additional frames. For example, if the object of interest is detected in the second frame, the process may be repeated for each of one or more additional frames until the object of interest is no longer detected. Thus, the object of interest can be tracked through multiple frames using the depth imager 101 in the present embodiment.

Both the illumination of the first type and the illumination of the second type in the exemplary process described above are generated by the optical sources 106. The illumination of the first type may comprise substantially uniform illumination over a designated field of view, and the illumination of the second type may comprise illumination of substantially only the second area, although other illumination types may be used in other embodiments.

The illumination of the second type may exhibit at least one of a different amplitude and a different frequency relative to the illumination of the first type. For example, in some embodiments, such as one or more ToF camera embodiments, the illumination of the first type comprises optical source output light having a first amplitude and varying in accordance with a first frequency and the illumination of the second type comprises optical source output light having a second amplitude different than the first amplitude and varying in accordance with a second frequency different than the first frequency.

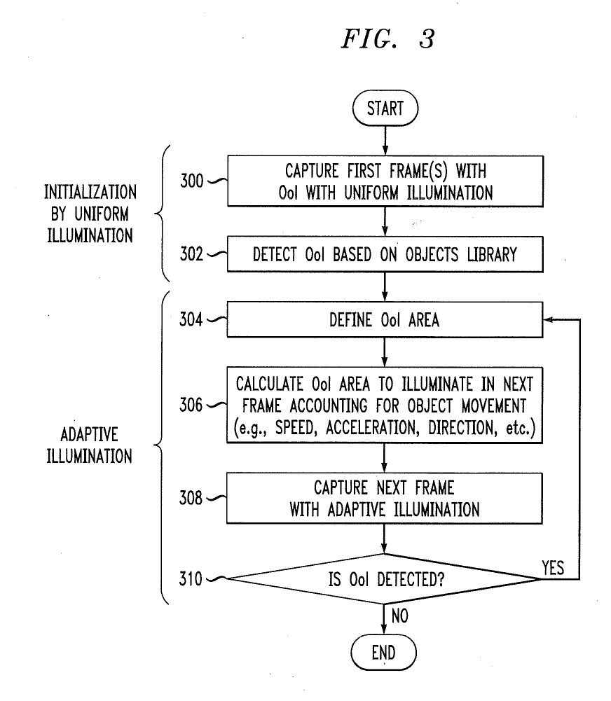

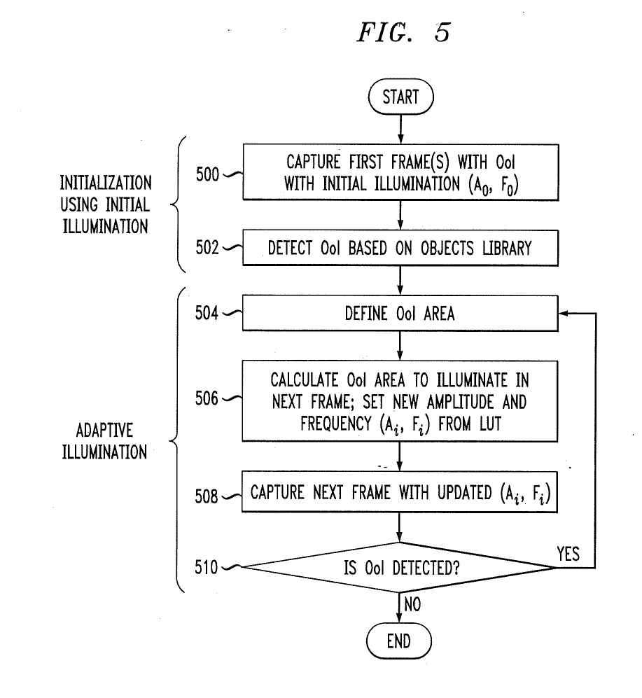

More detailed examples of the above-noted process will be described below in conjunction with the flow diagrams of FIGS. 3 and 5. In the FIG. 3 embodiment, the amplitude and frequency of the output light from the optical sources 106 is not varied, while in the FIG. 5 embodiment, the amplitude and frequency of the output light from the optical sources 106 is varied. Thus, the FIG. 5 embodiment makes use of depth imager 101 elements including an amplitude and frequency look-up table (LUT) 132 in memory 112 as well as an amplitude control module 134 and a frequency control module 136 in control circuitry 105 in varying the amplitude and frequency of the output light. The amplitude and frequency control modules 134 and 136 may be configured using techniques similar to those described in the above-cited U.S. patent application Ser. No. 13/658,153, and may be implemented in one or more driver circuits of the control circuitry 105.

For example, a driver circuit of control circuitry 105 in a given embodiment may comprise amplitude control module 134, such that a driver signal provided to at least one of the optical sources 106 varies in amplitude under control of the amplitude control module 134 in accordance with a designated type of amplitude variation, such as a ramped or stepped amplitude variation.

The ramped or stepped amplitude variation can be configured to provide, for example, an increasing amplitude as a function of time, a decreasing amplitude as a function of time, or combinations of increasing and decreasing amplitude. Also, the increasing or decreasing amplitude may follow a linear function or a non-linear function, or combinations of linear and non-linear functions.

In an embodiment with ramped amplitude variation, the amplitude control module 134 may be configured to permit user selection of one or more parameters of the ramped amplitude variation including one or more of a start amplitude, an end amplitude, a bias amplitude and a duration for the ramped amplitude variation.

Similarly, in an embodiment with stepped amplitude variation, the amplitude control module 134 may be configured to permit user selection of one or more parameters of the stepped amplitude variation including a one or more of a start amplitude, an end amplitude, a bias amplitude, an amplitude step size, a time step size and a duration for the stepped amplitude variation.

A driver circuit of control circuitry 105 in a given embodiment may additionally or alternatively comprise frequency control module 136, such that a driver signal provided to at least one of the optical sources 106 varies in frequency under control of the frequency control module 136 in accordance with a designated type of frequency variation, such as a ramped or stepped frequency variation.

The ramped or stepped frequency variation can be configured to provide, for example, an increasing frequency as a function of time, a decreasing frequency as a function of time, or combinations of increasing and decreasing frequency. Also, the increasing or decreasing frequency may follow a linear function or a non-linear function, or combinations of linear and non-linear functions. Moreover, the frequency variations may be synchronized with the previously-described amplitude variations if the driver circuit includes both amplitude control module 134 and frequency control module 136.

In an embodiment with ramped frequency variation, a frequency control module 136 may be configured to permit user selection of one or more parameters of the ramped frequency variation including one or more of a start frequency, an end frequency and a duration for the ramped frequency variation.

Similarly, in an embodiment with stepped frequency variation, the frequency control module 136 may be configured to permit user selection of one or more parameters of the stepped frequency variation including one or more of a start frequency, an end frequency, a frequency step size, a time step size and a duration for the stepped frequency variation.

A wide variety of different types and combinations of amplitude and frequency variations may be used in other embodiments, including variations following linear, exponential, quadratic or arbitrary functions.

It should be noted that the amplitude and frequency control modules 134 and 136 are utilized in an embodiment of depth imager 101 in which amplitude and frequency of output light can be varied, such as a ToF camera.

Other embodiments of depth imager 101 may include, for example, an SL camera in which the output light frequency is generally not varied. In such embodiments, the LUT 132 may comprise an amplitude-only LUT, and the frequency control module 136 may be eliminated, such that only the amplitude of the output light is varied using amplitude control module 134.

Numerous different control module configurations may be used in depth imager 101 to establish different amplitude and frequency variations for a given driver signal waveform. For example, static amplitude and frequency control modules may be used, in which the respective amplitude and frequency variations are not dynamically variable by user selection in conjunction with operation of the depth imager 101 but are instead fixed to particular configurations by design.

Thus, for example, a particular type of amplitude variation and a particular type of frequency variation may be predetermined during a design phase and those predetermined variations may be made fixed rather than variable in the depth imager. Static circuitry arrangements of this type providing at least one of amplitude variation and frequency variation for an optical source driver signal of a depth imager are considered examples of “control modules” as that term is broadly utilized herein, and are distinct from conventional arrangements such as ToF cameras that generally utilize CW output light having substantially constant amplitude and frequency.

As indicated above, the depth imager 101 comprises a plurality of modules 120 through 130 that are utilized in implementing image processing operations of the type mentioned above and utilized in the FIG. 3 and FIG. 5 processes. These modules include a frame capture module 120 configured to capture frames of a scene under varying illumination conditions, an objects library 122 storing predefined object templates or other information characterizing typical objects of interest to be detected in one or more of the frames, an area definition module 124 configured to define areas associated with a given object of interest or OoI in one or more of the frames, an object detection module 126 configured to detect the object of interest in one or more frames, and a movement calculation module 128 configured to identify areas to be adaptively illuminated based on expected movement of the object of interest from frame to frame. These modules may be implemented at least in part in the form of software stored in memory 112 and executed by processor 110.

Also included in the depth imager 101 in the present embodiment is a parameter optimization module 130 that is illustratively configured to optimize the integration time window of the depth imager 101 as well as optimization of the amplitude and frequency variations provided by respective amplitude and frequency control modules 134 and 136 for a given imaging operation performed by the depth imager 101. For example, the parameter optimization module 130 may be configured to determine an appropriate set of parameters including integration time window, amplitude variation and frequency variation for the given imaging operation.

Such an arrangement allows the depth imager 101 to be configured for optimal performance under a wide variety of different operating conditions, such as distance to objects in the scene, number and type of objects in the scene, and so on. Thus, for example, integration time window length of the depth imager 101 in the present embodiment can be determined in conjunction with selection of driver signal amplitude and frequency variations in a manner that optimizes overall performance under particular conditions.

The parameter optimization module 130 may also be implemented at least in part in the form of software stored in memory 112 and executed by processor 110. It should be noted that terms such as “optimal” and “optimization” as used in this context are intended to be broadly construed, and do not require minimization or maximization of any particular performance measure.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system. For example, other arrangements of processing modules and other components may be used in implementing the depth imager 101. Accordingly, functionality associated with multiple ones of the modules 120 through 130 in the FIG. 1 embodiment may be combined into a lesser number of modules in other embodiments. Also, components such as control circuitry 105 and processor 110 can be at least partially combined.

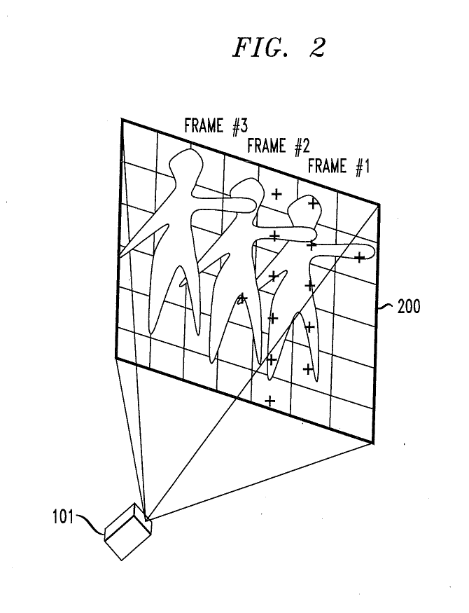

The operation of the depth imager 101 in various embodiments will now be described in more detail with reference to FIGS. 2 through 5. As will be described, these embodiments involve adaptively illuminating only a portion of a field of view associated with an object of interest when capturing subsequent frames, after initially detecting the object of interest in a first frame using illumination of the entire field of view. Such arrangements can reduce the computation and storage requirements associated with tracking the object of interest from frame to frame, thereby lowering power consumption within the image processing system. In addition, detection accuracy is improved by reducing interference from other portions of the field of view when processing the subsequent frames.

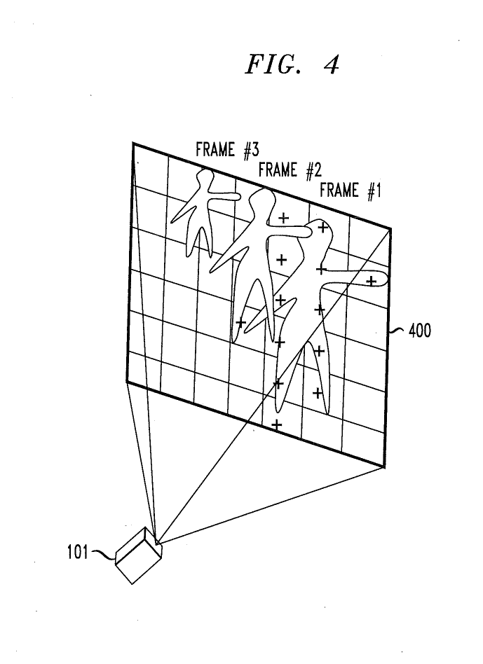

In the embodiment to be described in conjunction with FIGS. 2 and 3, the amplitude and frequency of the depth imager output light are not varied, while in the embodiment to be described in conjunction with FIGS. 4 and 5, the amplitude and frequency of the depth imager output light are varied. It is assumed for the latter embodiment that the depth imager 101 comprises a ToF camera or other type of 3D imager, although the disclosed techniques can be adapted in a straightforward manner to provide amplitude variation in an embodiment in which the depth imager comprises an SL camera.

Referring now to FIG. 2, depth imager 101 is configured to capture frames of a scene 200 in which an object of interest in the form of a human figure moves laterally within the scene from frame to frame without significantly altering its size within the captured frames. In this example, the object of interest is shown as having a different position in each of three consecutive captured frames denoted Frame #1, Frame #2 and Frame #3.

The object of interest is detected and tracked in these multiple frames using the process illustrated by the flow diagram of FIG. 3, which includes steps 300 through 310. Steps 300 and 302 are generally associated with an initialization by uniform illumination, while steps 304, 306, 308 and 310 involve use of adaptive illumination.

In step 300, the first frame including the object of interest is captured with uniform illumination. This uniform illumination may comprise substantially uniform illumination over a designated field of view, and is an example of what is more generally referred to herein as illumination of a first type.

In step 302, the object of interest is detected in the first frame using object detection module 126 and predefined object templates or other information characterizing typical objects of interest as stored in the objects library 122. The detection process may involve, for example, comparing various identified portions of the frame with sets of predefined object templates from the objects library 122.

In step 304, a first area associated with the object of interest in the first frame is defined, using area definition module 124. An example of the first area defined in step 304 may be considered the area identified by multiple+marks in FIG. 2.

In step 306, a second area to be adaptively illuminated in the next frame is calculated based on expected movement of the object of interest from frame to frame, also using area definition module 124. Thus, definition of the second area in step 306 takes into account object movement from frame to frame, considering factors such as, for example, speed, acceleration, and direction of movement.

In a given embodiment, this area definition may more particularly involve contour motion prediction based on position as well as speed and linear acceleration in multiple in-plane and out-of-plane directions. The resulting area definition may be characterized not only by a contour but also by an associated epsilon neighborhood. Motion prediction algorithms of this type and suitable for use in embodiments of the invention are well-known to those skilled in the art, and therefore not described in further detail herein.

Also, different types of area definitions may be used for different types of depth imagers. For example, area definition may be based on pixel blocks for a ToF camera and on contours and epsilon neighborhoods for an SL camera.

In step 308, the next frame is captured using adaptive illumination. This frame is the second frame in a first pass through the steps of the process. In the present embodiment, adaptive illumination may be implemented as illumination of substantially only the second area determined in step 306. This is an example of what is more generally referred to herein as illumination of a second type. The adaptive illumination applied in step 308 in the present embodiment may have the same amplitude and frequency as the substantially uniform illumination applied in step 300, but is adaptive in the sense that it is applied to only the second area rather than to the entire field of view. In the embodiment to be described in conjunction with FIGS. 4 and 5, the adaptive illumination is also varied in at least one of amplitude and frequency relative to the substantially uniform illumination.

In adaptively illuminating only a portion of a field of view of a depth imager comprising a ToF camera, certain LEDs in an optical source comprising an LED array of the ToF camera may be turned off. In the case of a depth imager comprising an SL camera, the illuminated portion of the field of view may be adjusted by controlling the scanning range of the mechanical laser scanning system.

In step 310, a determination is made as to whether or not an attempt to detect the object of interest in the second frame has been successful. If the object of interest is detected in the second frame, steps 304, 306 and 308 are repeated for one or more additional frames, until the object of interest is no longer detected. Thus, the FIG. 3 process allows the object of interest to be tracked through multiple frames.

As noted above, it is also possible that the adaptive illumination will involve varying at least one of the amplitude and frequency of the output of the depth imager 101 using the respective amplitude and frequency control modules 134 and 136. Such variations may be particularly useful in situations such as that illustrated in FIG. 4, where depth imager 101 is configured to capture frames of a scene 400 in which an object of interest in the form of a human figure not only moves laterally within the scene from frame to frame but also significantly alters its size within the captured frames. In this example, the object of interest is shown as not only having a different position in each of three consecutive captured frames denoted Frame #1, Frame #2 and Frame #3, but also moving further away from the depth imager 101 from frame to frame.

The object of interest is detected and tracked in these multiple frames using the process illustrated by the flow diagram of FIG. 5, which includes steps 500 through 510. Steps 500 and 502 are generally associated with an initialization using an initial illumination having particular amplitude and frequency values, while steps 504, 506, 508 and 510 involve use of adaptive illumination having amplitude and frequency values that differ from those of the initial illumination.

In step 500, the first frame including the object of interest is captured with the initial illumination. This initial illumination has amplitude A₀ and frequency F₀ and is applied over a designated field of view, and is another example of what is more generally referred to herein as illumination of a first type.

In step 502, the object of interest is detected in the first frame using object detection module 126 and predefined object templates or other information characterizing typical objects of interest as stored in the objects library 122. The detection process may involve, for example, comparing various identified portions of the frame with sets of predefined object templates from the objects library 122.

In step 504, a first area associated with the object of interest in the first frame is defined, using area definition module 124. An example of the first area defined in step 504 may be considered the area identified by multiple+marks in FIG. 4.

In step 506, a second area to be adaptively illuminated in the next frame is calculated based on expected movement of the object of interest from frame to frame, also using area definition module 124. As in the FIG. 3 embodiment, definition of the second area in step 506 takes into account object movement from frame to frame, considering factors such as, for example, speed, acceleration, and direction of movement. However, step 506 also sets new amplitude and frequency values Aᵢ and Fᵢ for subsequent adaptive illumination, as determined from the amplitude and frequency LUT 132 of memory 112 within depth imager 101, where i denotes a frame index.

In step 508, the next frame is captured using adaptive illumination having the updated amplitude Aᵢ and frequency Fᵢ. This frame is the second frame in a first pass through the steps of the process. In the present embodiment, adaptive illumination may be implemented as illumination of substantially only the second area determined in step 506. This is another example of what is more generally referred to herein as illumination of a second type. As indicated above, the adaptive illumination applied in step 508 in the present embodiment has different amplitude and frequency value than the initial illumination applied in step 500. It is also adaptive in the sense that it is applied to only the second area rather than to the entire field of view.

In step 510, a determination is made as to whether or not an attempt to detect the object of interest in the second frame has been successful. If the object of interest is detected in the second frame, steps 504, 506 and 508 are repeated for one or more additional frames, until the object of interest is no longer detected. For each such iteration, different amplitude and frequency values may be determined for the adaptive illumination. Thus, the FIG. 5 process also allows the object of interest to be tracked through multiple frames, but provides improved performance by adjusting at least one of amplitude and frequency of the depth imager output light as the object of interest moves from frame to frame.

By way of example, in the FIG. 5 embodiment and other embodiments in which at least one of output light amplitude and frequency are adaptively varied, the illumination of the first type comprises output light having a first amplitude and varying in accordance with a first frequency, and the illumination of the second type comprises output light having a second amplitude different than the first amplitude and varying in accordance with a second frequency different than the first frequency.

With regard to the amplitude variation, the first amplitude is typically greater than the second amplitude if the expected movement of the object of interest is towards the depth imager, and the first amplitude is typically less than the second amplitude if the expected movement is away from the depth imager. Also, the first amplitude is typically greater than the second amplitude if the expected movement is towards a center of the scene, and the first amplitude is typically less than the second amplitude if the expected movement is away from a center of the scene.

With regard to the frequency variation, the first frequency is typically less than the second frequency if the expected movement is towards the depth imager, and the first frequency is typically greater than the second frequency if the expected movement is away from the depth imager.

As mentioned previously, the amplitude variations may be synchronized with the frequency variations, via appropriate configuration of the amplitude and frequency LUT 132. However, other embodiments may utilize only frequency variations or only amplitude variations. For example, use of ramped or stepped frequency with constant amplitude may be beneficial in cases in which the scene to be imaged comprises multiple objects located at different distances from the depth imager.

As another example, use of ramped or stepped amplitude with constant frequency may be beneficial in cases in which the scene to be imaged comprises a single primary object that is moving either toward or away from the depth imager, or moving from a periphery of the scene to a center of the scene or vice versa. In such arrangements, a decreasing amplitude is expected to be well suited for cases in which the primary object is moving toward the depth imager or from the periphery to the center, and an increasing amplitude is expected to be well suited for cases in which the primary object is moving away from the depth imager or from the center to the periphery.

The amplitude and frequency variations in the embodiment of FIG. 5 can significantly improve the performance of a depth imager such as a ToF camera. For example, such variations can extend the unambiguous range of the depth imager 101 without adversely impacting measurement precision, at least in part because the frequency variations permit superimposing of detected depth information for each frequency. Also, a substantially higher frame rate can be supported than would otherwise be possible using conventional CW output light arrangements, at least in part because the amplitude variations allow the integration time window to be adjusted dynamically to optimize performance of the depth imager, thereby providing improved tracking of dynamic objects in a scene. The amplitude variations also result in better reflection from objects in the scene, further improving depth image quality.

It is to be appreciated that the particular processes illustrated in FIGS. 2 through 5 are presented by way of example only, and other embodiments of the invention may utilize other types and arrangements of process operations for providing adaptive illumination using a ToF camera, SL camera or other type of depth imager. For example, the various steps of the flow diagrams of FIGS. 3 and 5 may be performed at least in part in parallel with one another rather than serially as shown. Also, additional or alternative process steps may be used in other embodiments. As one example, in the FIG. 5 embodiment, substantially uniform illumination may be applied after each set of a certain number of iterations of the process, for calibration or other purposes.

It should again be emphasized that the embodiments of the invention as described herein are intended to be illustrative only. For example, other embodiments of the invention can be implemented utilizing a wide variety of different types and arrangements of image processing systems, depth imagers, image processing circuitry, control circuitry, modules, processing devices and processing operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising:
capturing a first frame of a scene using illumination of a first type;
defining a first area associated with an object of interest in the first frame;
identifying a second area to be adaptively illuminated based on expected movement of the object of interest;
capturing a second frame of the scene with adaptive illumination of the second area using illumination of a second type different than the first type; and
attempting to detect the object of interest in the second frame.

2. The method of claim 1 wherein the method is implemented in at least one processing device comprising a processor coupled to a memory.

3. The method of claim 1 wherein the method is implemented in a depth imager.

4. The method of claim 1 wherein the illumination of the first type comprises substantially uniform illumination over a designated field of view.

5. The method of claim 1 wherein the illumination of the second type comprises illumination of substantially only the second area.

6. The method of claim 1 wherein the illumination of the first type comprises optical source output light having a first amplitude and the illumination of the second type comprises optical source output light having a second amplitude different than the first amplitude.

7. The method of claim 6 wherein the first amplitude is greater than the second amplitude if the expected movement is towards the optical source.

8. The method of claim 6 wherein the first amplitude is less than the second amplitude if the expected movement is away from the optical source.

9. The method of claim 6 wherein the first amplitude is greater than the second amplitude if the expected movement is towards a center of the scene.

10. The method of claim 6 wherein the first amplitude is less than the second amplitude if the expected movement is away from a center of the scene.

11. The method of claim 1 wherein the illumination of the first type comprises optical source output light varying in accordance with a first frequency and the illumination of the second type comprises optical source output light varying in accordance with a second frequency different than the first frequency.

12. The method of claim 11 wherein the first frequency is less than the second frequency if the expected movement is towards the optical source.

13. The method of claim 11 wherein the first frequency is greater than the second frequency if the expected movement is away from the optical source.

14. The method of claim 1 wherein the illumination of the first type comprises optical source output light having a first amplitude and varying in accordance with a first frequency and the illumination of the second type comprises optical source output light having a second amplitude different than the first amplitude and varying in accordance with a second frequency different than the first frequency.

15. The method of claim 1 further comprising determining if the object of interest is detected in the second frame.

16. The method of claim 15 wherein if the object of interest is detected in the second frame, repeating the defining, identifying, capturing and attempting for each of one or more additional frames until the object of interest is no longer detected.

17. A computer-readable storage medium having computer program code embodied therein, wherein the computer program code when executed in a processing device causes the processing device to perform the method of claim 1.

18. An apparatus comprising:
a depth imager comprising at least one optical source;
wherein the depth imager is configured to capture a first frame of a scene using illumination of a first type, to define a first area associated with an object of interest in the first frame, to identify a second area to be adaptively illuminated based on expected movement of the object of interest, to capture a second frame of the scene with adaptive illumination of the second area using illumination of a second type different than the first type, and to attempt to detect the object of interest in the second frame;
wherein the illumination of the first type and the illumination of the second type are generated by the optical source.

19. The apparatus of claim 18 wherein the illumination of the first type comprises substantially uniform illumination over a designated field of view.

20. The apparatus of claim 18 wherein the illumination of the second type comprises illumination of substantially only the second area.

21. An apparatus comprising:
at least one processing device comprising a processor coupled to a memory and implementing:
a frame capture module configured to capture a first frame of a scene using illumination of a first type;
an area definition module configured to define a first area associated with an object of interest in the first frame;
a movement calculation module configured to identify a second area to be adaptively illuminated based on expected movement of the object of interest; and
an object detection module;
wherein the frame capture module is further configured to capture a second frame of the scene with adaptive illumination of the second area using illumination of a second type different than the first type; and
wherein the object detection module is configured to attempt to detect the object of interest in the second frame.

22. The apparatus of claim 21 wherein the processing device comprises a depth imager.

23. The apparatus of claim 22 wherein the depth imager comprises one of a time of flight camera and a structured light camera.

24. An image processing system comprising the apparatus of claim 21.
